(19) United States
(12) Patent Application Publication
(10) Pub. No.: US 2015/0109272 A1
(43) Pub. Date: Apr. 23, 2015

(54) Array substrate and 3D display device

(71) Applicants: Chenghung Chen, Shenzhen (CN); Jiali Jiang, Shenzhen (CN)

(72) Inventors: Chenghung Chen, Shenzhen (CN); Jiali Jiang, Shenzhen (CN)

(21) Appl. No.: 14/234,426

(22) PCT Filed: Nov. 18, 2013
(86) PCT No.: PCT/CN2013/087351

§ 371 Date: Jan. 23, 2014

(30) Foreign Application Priority Data
Oct. 22, 2013 (CN) 201310497396.0

(51) Int. Cl. G09G 3/20

(52) U.S. Cl. CPC G09G 3/2092; G09G 2310/06; G09G 2320/0233; G09G 2310/0262; G09G 2300/08
USPC 345/208

(57) ABSTRACT

In the present invention, after the corresponding thin-film transistor is turned on by a first scan line, charging is achieved through a pixel electrode. After that, the corresponding thin-film transistor is turned on by a second scan line. The common voltage starts to be applied to the pixel electrode. In such a manner, the insertion of grey-scale pictures is carried out. Moreover, the embodiments of the present invention control the duration of time of a second scan signal on the second scan line so as to pull down the voltage of the pixel electrode to different voltage levels, thereby achieving the insertion of grey-scale pictures with varied brightness.

### BACKGROUND OF THE INVENTION

1. Field of the Invention

The present invention relates to a 3D display technology, and more particularly, to an array substrate and a 3D display device.

2. Description of Prior Art

As 3D applications are gradually propagated and promoted, the demands on 3D technology are higher and higher.

3D shutter glasses often use a technology called Black Insertion or BLU Blinking Mode, which is a backlight scan mode with insertion of black pictures. In this 3D technology, when inserting the black pictures, it is often controlled by TCON (a timing controller) or SE (a converter) of a 3D display. This technology is carried out by inserting black pictures when the left-eye and right-eye signals are switched. For example, one black picture is inserted in the end of a right-eye frame and then a left-eye frame is scanned and displayed.

However, this technology is only able to insert the black pictures. That is, only one kind of brightness for the grey-scale picture (pure black) is able to be displayed. This technology cannot insert pictures with varied brightness according to different 3D modes. This limits the development of 3D display technology. For instance, when a high-brightness grey-scale picture is required, it may lead the 3D display quality become worse (e.g., low brightness) if just inserting the black pictures.

Therefore, there is a need to solve above technical problems occurred in the existing technical skills.

### SUMMARY OF THE INVENTION

Regarding this, the present invention provides an array substrate and a 3D display device for solving the technical problem of display quality decreased in displaying high-brightness pictures, resulted from only one type of grey-level picture being displayed in a BLU blinking mode with insertion of black pictures in a 3D display technology existed in conventional skills.

To solve above technical problems, the present invention constructs an array substrate, which comprises data lines extended along a column direction and scan lines and common electrode lines extended along a row direction. The data lines and the scan lines are perpendicular to each other and are arranged as a matrix so as to form a plurality of pixel units. Each pixel unit has a pixel electrode, a first thin-film transistor, and a second thin-film transistor disposed therein.

The scan lines comprise a first scan line and a second scan line. The first scan line is connected to the pixel electrode via the first thin-film transistor. The second scan line is connected to the pixel electrode via the second thin-film transistor.

Amongst, the first scan line is used to transmit a first scan signal so as to turn on the first thin-film transistor.

The data line is used to provide a pixel electrode voltage to the pixel electrode via the first thin-film transistor so as to charge up through the pixel electrode after the first thin-film transistor is turned on.

The second scan line is used to transmit a second scan signal so as to turn on the second thin-film transistor after charging up by using the data line through the pixel electrode.

The common electrode line is used to provide a common voltage to the pixel electrode via the second thin-film transistor so as to pull down the pixel electrode voltage to the common voltage after the second thin-film transistor is turned on.

Amongst, the duration of the second scan signal on the second scan line is a predetermined time such that the voltage of the pixel electrode can be pulled down to different voltage levels.

To solve above technical problems, the embodiments of the present invention also construct a 3D display device, which comprises an array substrate. The array substrate comprises data lines extended along a column direction and scan lines and common electrode lines extended along a row direction. The data lines and the scan lines are perpendicular to each other and are arranged as a matrix so as to form a plurality of pixel units. Each pixel unit has a pixel electrode, a first thin-film transistor, and a second thin-film transistor disposed therein.

The scan lines comprise a first scan line and a second scan line. The first scan line is connected to the pixel electrode via the first thin-film transistor. The second scan line is connected to the pixel electrode via the second thin-film transistor.

Amongst, the first scan line is used to transmit a first scan signal so as to turn on the first thin-film transistor.

The data line is used to provide a pixel electrode voltage to the pixel electrode via the first thin-film transistor so as to charge up through the pixel electrode after the first thin-film transistor is turned on.

The second scan line is used to transmit a second scan signal so as to turn on the second thin-film transistor after charging up by using the data line through the pixel electrode.

The common electrode line is used to provide a common voltage to the pixel electrode via the second thin-film transistor so as to pull down the pixel electrode voltage to the common voltage after the second thin-film transistor is turned on.

Amongst, the duration of the second scan signal on the second scan line is a predetermined time such that the voltage of the pixel electrode can be pulled down to different voltage levels.

In the embodiments of the present invention, the first scan line and the second scan line are arranged. After the corresponding thin-film transistor is turned on by the first scan line, charging is achieved through the pixel electrode. After that, the corresponding thin-film transistor is turned on by the second scan line. The common voltage starts to be applied to the pixel electrode. In such a manner, the insertion of grey-scale pictures is carried out. Moreover, the embodiments of the present invention control the duration of time of the second scan signal on the second scan line so as to pull down the voltage of the pixel electrode to different voltage levels, and thereby achieving the insertion of grey-scale pictures with varied brightness, not just the insertion of black pictures. The embodiments of the present invention can solve the technical problem of display quality decreased in displaying high-brightness pictures, resulted from only one type of grey-level picture being displayed in the existing technical skills.

To make above content of the present invention more easily understood, it will be described in details by using preferred embodiments in conjunction with the appending drawings.

### BRIEF DESCRIPTION OF THE DRAWINGS

FIG. 1 is a schematic diagram showing an array substrate according to a preferred embodiment of the present invention.

FIG. 2A is a schematic diagram showing driving waveforms of a first scan line and a second scan line according to an embodiment of the present invention.

FIG. 2B is a schematic diagram showing driving waveforms of the first scan line and the second scan line according to another embodiment of the present invention.

FIG. 2C is a schematic diagram showing a time sequence to insert grey-scale pictures. FIGS. 3A-3C are schematic diagrams illustrating the effects of the embodiments of the present invention.

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “inner”, “outer”, “lateral”, and the like, may be used herein for case of description as illustrated in the figures. Therefore, it will be understood that the spatially relative terms are intended to illustrate for understanding the present invention, but not to limit the present invention. In the appending drawings, units having similar structures are labeled by the same reference numbers.

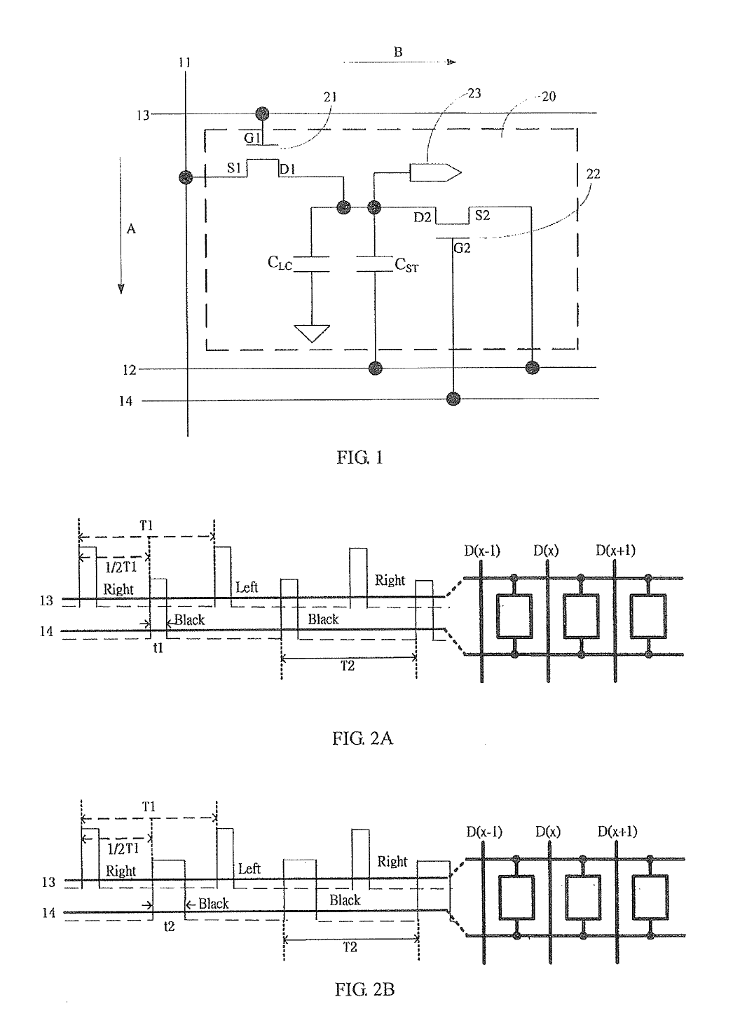

Please refer to FIG. 1, which is a schematic diagram showing an array substrate according to a preferred embodiment of the present invention. The array substrate comprises a data line 11 extended along a column direction A, and also comprises a common electrode line 12, a first scan line 13, and a second scan line 14 that are extended along a row direction B. The data line 11 is perpendicular to both of the first scan line 13 and the second scan line 14 and they are arranged as a matrix so as to form a plurality of pixel units 20. Of course, FIG. 1 merely shows one single pixel unit. Other pixel units have similar structures as shown in FIG. 1 and they are not detailed herein.

Referring to FIG. 1, the pixel unit 20 comprises a first thin-film transistor 21, a second thin-film transistor 22, a liquid crystal capacitor C_{LC}, and a storage capacitor C_{ST}, and of course comprises a pixel electrode 23. The pixel electrode 23 shown in FIG. 1 is merely a schematic presentation. In practical implementations, the pixel electrode 23 is a layer structure parallel to the array substrate.

The first scan line 13 is connected to the pixel electrode 23 via the first thin-film transistor 21, and the second scan line 14 is connected to the pixel electrode 23 via the second thin-film transistor 22.

Specifically, referring to FIG. 1, the first thin-film transistor 21 comprises a first gate electrode G1, a first source electrode S1, and a first drain electrode D1. The first gate electrode G1 of the first thin-film transistor 21 is electrically connected to the first scan line 13. The first source electrode S1 of the first thin-film transistor 21 is electrically connected to the data line 11. The first drain electrode D1 of the first thin-film transistor 21 is electrically connected to the pixel electrode 23.

Similarly, the second thin-film transistor 22 comprises a second gate electrode G2, a second source electrode S2, and a second drain electrode D2. The second gate electrode G2 of the second thin-film transistor 22 is electrically connected to the second scan line 14. The second source electrode S2 of the second thin-film transistor 22 is electrically connected to the common electrode line 12. The second drain electrode D2 of the second thin-film transistor 22 is electrically connected to the pixel electrode 23.

In practical implementations, the first scan line 13 is used to transmit a first scan signal so as to turn on the first gate electrode G1 of the first thin-film transistor 21, in which the first scan signal may come from a gate driving chip (not shown), for example. The data line 11. provides a pixel electrode voltage to the pixel electrode 23 via the first thin-film transistor 21 so as to make charging achieved through the pixel electrode 23 to display a left-eye pixel image or a right-eye pixel image corresponding thereto. After charging is finished, the pixel electrode 23 maintains at an electricity remaining state. Meanwhile, the second scan line 14 transmits a second scan signal so as to turn on the second gate electrode G2 of the second thin-film transistor 22, and the common electrode line 12 provides a common voltage to the pixel electrode 23 via the second thin-film transistor 22 so as to pull down the voltage of the pixel electrode 23 to the common voltage. Moreover, in the embodiments of the present invention, the duration of the second scan signal on the second scan line 14 is a predetermined time. In such a manner, the voltage of the pixel electrode 23 can be pulled down to different voltage levels, thereby achieving the insertion of grey-scale pictures with varied brightness.

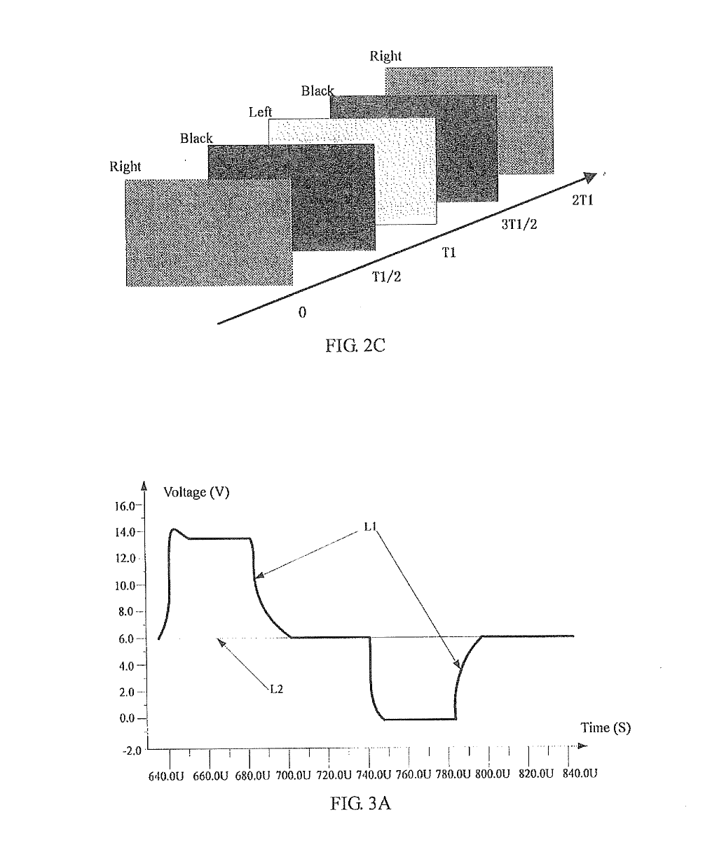

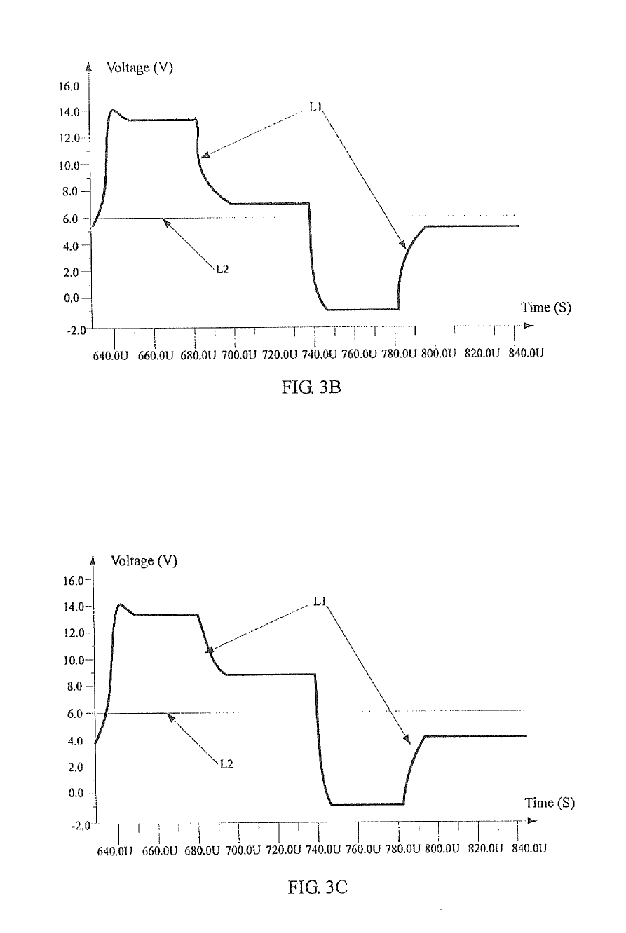

Please refer to FIGS. 2A-2C. FIG. 2A is a schematic diagram showing driving waveforms of the first scan line 13 and the second scan line 14 according to an embodiment of the present invention. FIG. 2B is a schematic diagram showing driving waveforms of the first scan line 13 and the second scan line 14 according to another embodiment of the present invention. FIG. 2C is a schematic diagram showing a time sequence to insert grey-scale pictures.

The first scan line 13 transmits the first scan signal so as to turn on the first gate electrode G1 of the first thin-film transistor 21. The data line 11 provides a voltage to the pixel electrode 23 through the first thin-film transistor 21 already turned on so as to make charging achieved through the pixel electrode 23 to display the left-eye pixel image (Left) or the right-eye pixel image (Right) corresponding thereto.

After charging is finished, i.e., after the corresponding left-eye pixel image (Left) or the corresponding right-eye pixel image (Right) is shown or displayed, the pixel electrode 23 maintains at the electricity remaining state. Meanwhile, the second scan line 14 transmits the second scan signal so as to turn on the second gate electrode G2 of the second thin-film transistor 22, and the common electrode line 12 provides the common voltage to the pixel electrode 23 through the second thin-film transistor 22 already turned on so as to pull down the voltage of the pixel electrode 23 to the common voltage. In such a manner, the insertion of grey-scale pictures is carried out.

The first scan signal has a first scan period T1 and the second scan signal has a second scan period T2. In the embodiment shown in FIG. 2A, the second scan signal continues for a predetermined time t1 during the second scan period T2. The predetermined time t1 is ranged between 0 and T2. In the embodiment shown in FIG. 2B, the second scan signal continues for a predetermined time t2 during the second scan period T2. The predetermined time t2 is ranged between 0 and T2. It is apparent that t2>t1. In the embodiments of the present invention, as the predetermined time t1, t2, . . . varies, the common voltage inputted from the common electrode line 12 may pull down the voltage of the pixel electrode 23 to different voltage levels, and thereby achieving the insertion of grey-scale pictures with varied brightness.

In brief, the embodiments of the present invention can adjust the brightness of the inserted pictures by controlling the duration of the second scan signal (i.e., the predetermined time).

The principles of controlling the duration of the second scan signal Gate2 to adjust the brightness of the inserted pictures in the present invention are as follows.

The first scan line 13 transmits the first scan signal so as to turn on the first gate electrode G1 of the first thin-film transistor 21. The data line 11 provides a voltage to the pixel electrode 23 through the first thin-film transistor 21 already turned on so as to make charging achieved through the pixel electrode 23. After charging is finished, the pixel electrode 23 maintains at the electricity remaining state. Meanwhile, there exists a voltage difference between the pixel electrode voltage of the pixel electrode 23 and the common electrode voltage of the common electrode line 12 on the two sides of the second thin-film transistor 22. The aforesaid voltage difference has the largest value at the time the second gate electrode G2 of the second thin-film transistor 22 is turned on. At this moment, the inserted picture is the brightest one. However, the longer the second gate electrode G2 of the second thin-film transistor 22 is turned on, the more the aforesaid voltage difference decreases gradually. The charges of the two sides of the second thin-film transistor 22 are redistributed. The inserted picture becomes dark gradually until the aforesaid voltage difference is reduced to zero. Meanwhile, the charges of the two sides of the second thin-film transistor 22 are balanced and the grey level of the inserted picture is the darkest one.

It is apparent that the embodiments of the present invention can adjust the grey-level brightness of the inserted pictures by controlling the length of time the second gate electrode G2 of the second thin-film transistor 22 is turned on. That is, the duration of time (i.e., the predetermined time) of the second scan signal is controlled so as to pull down the voltage (Vpixel) of the pixel electrode 23 to different voltage levels. Therefore, the insertion of grey-scale pictures with varied brightness is carried out, not just the black pictures.

It is preferred that the second scan period T2 of the second scan signal is equal to the first scan period T1 of the first scan line 13. Also, it is preferred that the second scan line 14 starts to transmit the second scan signal at (T1)/2 of the first scan signal. Of course, it also can transmit the second scan signal at any other time. These are fallen in the protective scope of the present invention,

Please refer to FIGS. 3A-3C, which are schematic diagrams illustrating the effects of the embodiments of the present invention. L1 is the pixel electrode voltage when inserting just the black pictures. L2 is the voltage Vpixel of the pixel electrode 23 when controlling the predetermined time t (horizontal axis) of the second scan signal to vary in a certain range in the embodiments of the present invention. Obviously, compared to conventional skills, when the predetermined time t (horizontal axis) of the second scan signal is varied in a certain range in the embodiments of the present invention, the voltage Vpixel (vertical axis) of the pixel electrode 23 presents different values, i.e., displaying grey levels with different brightness.

The embodiments of the present invention also provide a 3D display device. The 3D display device comprises the array substrate provided in the embodiments of the present invention. Since the array substrate has been described detailedly in above contents, it is not repeated herein.

In the embodiments of the present invention, the first scan line and the second scan line are arranged. After the corresponding thin-film transistor is turned on by the first scan line, charging is achieved through the pixel electrode. After that, the corresponding thin-film transistor is turned on by the second scan line. The common voltage starts to be applied to the pixel electrode. In such a manner, the insertion of grey-scale pictures is carried out. Moreover, the embodiments of the present invention control the duration of time of the second scan signal on the second scan line so as to pull down the voltage of the pixel electrode to different voltage levels, and thereby achieving the insertion of grey-scale pictures with varied brightness, not just the insertion of black pictures.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An array substrate, which comprises data lines extended along a column direction and scan lines and common electrode lines extended along a row direction, the data lines and the scan lines are perpendicular to each other and are arranged as a matrix so as to form a plurality of pixel units, each pixel unit has a pixel electrode, a first thin-film transistor, and a second thin-film transistor disposed therein;
the scan lines comprise a first scan line and a second scan line, the first scan line is connected to the pixel electrode via the first thin-film transistor, the second scan line is connected to the pixel electrode via the second thin-film transistor;
the second thin-film transistor comprises a second gate electrode, a second source electrode, and a second drain electrode, the second gate electrode of the second thin-film transistor is electrically connected to the second scan line, the second source electrode of the second thin-film transistor is electrically connected to the common electrode line, the second drain electrode of the second thin-film transistor is electrically connected to the pixel electrode;
wherein the first scan line is used to transmit a first scan signal so as to turn on the first thin-film transistor;
the data line is used to provide a pixel electrode voltage to the pixel electrode via the first thin-film transistor so as to charge up through the pixel electrode after the first thin-film transistor is turned on;
the second scan line is used to transmit a second scan signal so as to turn on the second thin-film transistor after charging up by using the data line through the pixel electrode;
the common electrode line is used to provide a common voltage to the pixel electrode via the second thin-film transistor so as to pull down the pixel electrode voltage to the common voltage after the second thin-film transistor is turned on;
wherein the duration of the second scan signal on the second scan line is a predetermined time such that the voltage of the pixel electrode can be pulled clown to different voltage levels; the first scan line has a first scan period T1 and the predetermined time is ranged between 0 and T1.

2. The array substrate according to claim 1, wherein the second scan line has a second scan period T2, and the first scan period T1 is equal to the second scan period T2.

3. The array substrate according to claim 2, wherein the second scan line starts to transmit the second scan signal when the first scan signal is at (T1)/2.

4. An array substrate, which comprises data lines extended along a column direction and scan lines and common electrode lines extended along a row direction, the data lines and the scan lines are perpendicular to each other and are arranged as a matrix so as to form a plurality of pixel units, each pixel unit has a pixel electrode, a first thin-film transistor, and a second thin-film transistor disposed therein;
the scan lines comprise a first scan line and a second scan line, the first scan line is connected to the pixel electrode via the first thin-film transistor, the second scan line is connected to the pixel electrode via the second thin-film transistor;
wherein the first scan line is used to transmit a first scan signal so as to turn on the first thin-film transistor;
the data line is used to provide a pixel electrode voltage to the pixel electrode via the first thin-film transistor so as to charge up through the pixel electrode after the first thin-film transistor is turned on;
the second scan line is used to transmit a second scan signal so as to turn on the second thin-film transistor after charging up by using the data line through the pixel electrode;
the common electrode line is used to provide a common voltage to the pixel electrode via the second thin-film transistor so as to pull down the pixel electrode voltage to the common voltage after the second thin-film transistor is turned on;
wherein the duration of the second scan signal on the second scan line is a predetermined time such that the voltage of the pixel electrode can be pulled down to different voltage levels.

5. The array substrate according to claim 4, wherein the first scan line has a first scan period T1 and the predetermined time is ranged between 0 and T1.

6. The array substrate according to claim 5, wherein the second scan line has a second scan period T2, and the first scan period T1 is equal to the second scan period T2.

7. The array substrate according to claim 6, wherein the second scan line starts to transmit the second scan signal when the first scan signal is at (T1)/2.

8. The array substrate according to claim 4, wherein the second thin-film transistor comprises a second gate electrode, a second source electrode, and a second drain electrode, the second gate electrode of the second thin-film transistor is electrically connected to the second scan line, the second source electrode of the second thin-film transistor is electrically connected to the common electrode line, the second drain electrode of the second thin-film transistor is electrically connected to the pixel electrode.

9. A 3D display device, which comprises an array substrate, the array substrate comprises data lines extended along a column direction and scan lines and common electrode lines extended along a row direction, the data lines and the scan lines are perpendicular to each other and are arranged as a matrix so as to form a plurality of pixel units, each pixel unit has a pixel electrode, a first thin-film transistor, and a second thin-film transistor disposed therein;
the scan lines comprise a first scan line and a second scan line, the first scan line is connected to the pixel electrode via the first thin-film transistor, the second scan line is connected to the pixel electrode via the second thin-film transistor;
wherein the first scan line is used to transmit a first scan signal so as to turn on the first thin-film transistor;
the data line is used to provide a pixel electrode voltage to the pixel electrode via the first thin-film transistor so as to charge up through the pixel electrode after the first thin-film transistor is turned on;
the second scan line is used to transmit a second scan signal so as to turn on the second thin-film transistor after charging up by using the data line through the pixel electrode;
the common electrode line is used to provide a common voltage to the pixel electrode via the second thin-film transistor so as to pull down the pixel electrode voltage to the common voltage after the second thin-film transistor is turned on;
wherein the duration of the second scan signal on the second scan line is a predetermined time such that the voltage of the pixel electrode can be pulled down to different voltage levels.

10. The 3D display device according to claim 9, wherein the first scan line has a first scan period T1 and the predetermined time is ranged between 0 and T1.

11. The 3D display device according to claim 10, wherein the second scan line has a second scan period T2, and the first scan period T1 is equal to the second scan period T2.

12. The 3D display device according to claim 11, wherein the second scan line starts to transmit the second scan signal when the first scan signal is at (T1)/2.

13. The 3D display device according to claim 9, wherein the second thin-film transistor comprises a second gate electrode, a second source electrode, and a second drain electrode, the second gate electrode of the second thin-film transistor is electrically connected to the second scan line, the second source electrode of the second thin-film transistor is electrically connected to the common electrode line, the second drain electrode of the second thin-film transistor is electrically connected to the pixel electrode.
